(19) United States
(12) Patent Application Publication
(10) Pub. No.: US 2026/0057271 A1
(43) Pub. Date: Feb. 26, 2026

(54) CREATING, BRAIDING, AND FUSING NON-ABELIAN ANYONS ON A TRAPPED-ION PROCESSOR

(71) Applicant: Quantinuum LTD, London (GB)

(72) Inventors: Henrik DREYER, Munich (DE); Mohsin IQBAL, Munich (DE); Ruben VERRESEN, Cambridge, MA (US); Nathanan TANTIVASADAKARN, Pasadena, CA (US); Ashvin VISHWANATH, Cambridge, MA (US)

(21) Appl. No.: 18/635,606

(22) Filed: Apr. 15, 2024

Related U.S. Application Data
(60) Provisional application No. 63/496,547, filed on Apr. 17, 2023.

(51) Int. Cl. G06N 10/40

(52) U.S. Cl. CPC G06N 10/40

(57) ABSTRACT

Non-Abelian anyons are created, braided, and fused using the physical qubits of a QCCD-based quantum processor. A controller controls operation of a confinement apparatus to cause a plurality of physical qubits to be confined by the confinement apparatus. At least some of the plurality of physical qubits are logically organized onto a lattice and have been prepared to provide a non-Abelian topological order ground state. The lattice is formed of a plurality of sublattices. The controller causes performance of an anyon creation gate to cause creation of a first pair of non-Abelian anyons on a sublattice of the plurality of sublattices; causes a path traversal gate sequence to be performed to cause at least a first anyon of the first pair of anyons to traverse a braiding path to form a closed loop on the sublattice; and determines a fusion channel formed by fusing the first pair of anyons.

### CROSS-REFERENCE TO RELATED APPLICATIONS

This application claims priority to U.S. Application No. 63/496,547, filed Apr. 17, 2023, the content of which is incorporated herein by reference in its entirety.

### TECHNICAL FIELD

Various embodiments relate to creating, braiding, and/or fusing non-Abelian anyons using entangled quantum objects. For example, various embodiments relate to the creation, braiding, and/or fusing of non-Abelian anyons using the physical qubits of quantum charge-coupled device (QCCD)-based quantum processor.

### BACKGROUND

Complex quantum computations demand levels of precision that are not available in conventional quantum computers. For example, conventional quantum computers are noise-limited due to imperfect control and noise in gate operations between data qubits, for example. Through applied effort, ingenuity, and innovation many deficiencies of prior systems have been solved by developing solutions that are structured in accordance with the embodiments of the present invention, many examples of which are described in detail herein.

### SUMMARY OF SOME EXAMPLE EMBODIMENTS

Various embodiments provide methods, systems, system controllers, and/or the like for manipulating a state of a non-Abelian topological order using entangled quantum objects, such as the physical qubits of a quantum charge-coupled device (QCCD)-based quantum processor. For example, in various embodiments, non-Abelian anyons may be created. The non-Abelian anyons may be braided with one another and fused to cause generation of respective fusion channels. The fusion channels generated will be dependent on how the anyons were braided.

According to an aspect of the present disclosure, a method for creating, braiding, and fusing non-Abelian anyons is provided. In an example embodiment, the method is performed by a controller configured to control operation of various components of an atomic and/or quantum system. In an example embodiment, the method includes controlling operation of a confinement apparatus to cause a plurality of physical qubits to be confined by the confinement apparatus. At least some of the plurality of physical qubits are logically organized onto a lattice and have been prepared to provide a non-Abelian topological order ground state. The lattice comprises a plurality of vertices connected by edges, wherein the lattice is formed of a plurality of sublattices. Each sublattice comprises a respective plurality of vertices of the plurality of vertices and the respective plurality of vertices of a sublattice of the plurality of sublattices are connected by edges to form the sublattice. The method further includes causing performance of an anyon creation gate to cause creation of a first pair of non-Abelian anyons on a first sublattice of the plurality of sublattices; causing a path traversal gate sequence to be performed to cause at least a first anyon of the first pair of non-Abelian anyons to traverse a first braiding path to form a closed loop on the first sublattice; and determining a first fusion channel of fusing the first pair of non-Abelian anyons.

In an example embodiment, the anyon creation gate is an X-gate and causing generation of the first pair of non-Abelian anyons on the first sublattice comprises performing an X-gate on a creation location first vertex qubit of the first sublattice, the creation location first vertex qubit being a physical qubit of the plurality of physical qubits assigned to a vertex of the first sublattice that links a creation location of the first anyon of the first pair of non-Abelian anyons and a creation location of a second anyon of the first pair of non-Abelian anyons.

In an example embodiment, the path traversal gate sequence comprises a plurality of Pauli-X gates performed on vertices of the first sublattice along the braiding path and a plurality of controlled Z-gates each performed on a respective pair of physical qubits that includes a second vertex qubit and a third vertex qubit, wherein the second vertex qubit is a physical qubit of the plurality of physical qubits that is assigned to a vertex of the second sublattice and the third vertex qubit is a physical qubit of the plurality of physical qubits that is assigned to a vertex of the third sublattice.

In an example embodiment, the plurality of controlled Z-gates comprises controlled Z-gates performed on each third vertex qubit along the first braiding path with each preceding second vertex qubit along the first braiding path.

In an example embodiment, the method further includes causing generation of a second pair of non-Abelian anyons on a second lattice of the plurality of sublattices, wherein performance of the path traversal gate sequence further causes at least a first anyon of the second pair of non-Abelian anyons to traverse a second braiding path to form a closed loop on the second sublattice so as to form a second fusion channel.

In an example embodiment, the first fusion channel is one of a plurality of possible fusion channels for the first pair of non-Abelian anyons and any crossings of the first braiding path and the second braiding path affects which fusion channel of the plurality of possible fusion channels is formed as the first fusion channel.

In an example embodiment, determining the first fusion channel comprises determining one or more expectation values for one or more operators defined on the lattice.

In an example embodiment, the method further includes determining a creation location first vertex qubit and the first braiding path; and generating a set of machine level executable instructions for causing performance of the anyon creation gate and the path traversal gate sequence.

In an example embodiment, a gate used to create the first pair of non-Abelian anyons and each gate of the path traversal gate sequence performed on the first sublattice is controlled by one or more ancilla qubits of the plurality of physical qubits.

In an example embodiment, the lattice is a Kagome lattice having periodic boundary conditions.

According to another aspect, a system configured for creating, braiding, and fusing non-Abelian anyons is provided. In an example embodiment, the system includes a confinement apparatus configured to confine a plurality of physical qubits; one or more manipulation sources configured to generate respective manipulation signals for interaction with respective physical qubits of the plurality of physical qubits; and a controller configured to control operation of the confinement apparatus and the one or more manipulation sources. The controller is configured to perform controlling operation of the confinement apparatus to cause the plurality of physical qubits to be confined by the confinement apparatus. At least some physical qubits of the plurality of physical qubits are logically organized onto a lattice and have been prepared to provide a non-Abelian topological order ground state. The lattice comprises a plurality of vertices connected by edges. The lattice is formed of a plurality of sublattices, wherein each sublattice comprises a respective plurality of vertices of the plurality of vertices. The respective plurality of vertices of a sublattice of the plurality of sublattices are connected by edges to form the sublattice. The controller is further configured to perform causing performance of an anyon creation gate to cause creation of a first pair of non-Abelian anyons on a first sublattice of the plurality of sublattices; causing a path traversal gate sequence to be performed to cause at least a first anyon of the first pair of non-Abelian anyons to traverse a first braiding path to form a closed loop on the first sublattice; and determining a first fusion channel of fusing the first pair of non-Abelian anyons.

In an example embodiment, the anyon creation gate is an X-gate and causing generation of the first pair of non-Abelian anyons on the first sublattice comprises performing an X-gate on a creation location first vertex qubit of the first sublattice, the creation location first vertex qubit being a physical qubit of the plurality of physical qubits assigned to a vertex of the first sublattice that links a creation location of the first anyon of the first pair of non-Abelian anyons and a creation location of a second anyon of the first pair of non-Abelian anyons.

In an example embodiment, the path traversal gate sequence comprises a plurality of Pauli-X gates performed on vertices of the first sublattice along the braiding path and a plurality of controlled Z-gates each performed on a respective pair of physical qubits that includes a second vertex qubit and a third vertex qubit, wherein the second vertex qubit is a physical qubit of the plurality of physical qubits that is assigned to a vertex of the second sublattice and the third vertex qubit is a physical qubit of the plurality of physical qubits that is assigned to a vertex of the third sublattice.

In an example embodiment, the plurality of controlled Z-gates comprises controlled Z-gates performed on each third vertex qubit along the first braiding path with each preceding second vertex qubit along the first braiding path.

In an example embodiment, the controller is further configured to perform causing generation of a second pair of non-Abelian anyons on a second lattice of the plurality of sublattices, wherein performance of the path traversal gate sequence further causes at least a first anyon of the second pair of non-Abelian anyons to traverse a second braiding path to form a closed loop on the second sublattice so as to form a second fusion channel.

In an example embodiment, the first fusion channel is one of a plurality of possible fusion channels for the first pair of non-Abelian anyons and any crossings of the first braiding path and the second braiding path affects which fusion channel of the plurality of possible fusion channels is formed as the first fusion channel.

In an example embodiment, determining the first fusion channel comprises determining one or more expectation values for one or more operators defined on the lattice.

In an example embodiment, the controller is further configured to perform determining a creation location first vertex qubit and the first braiding path; and generating a set of machine level executable instructions for causing performance of the anyon creation gate and the path traversal gate sequence.

In an example embodiment, a gate used to create the first pair of non-Abelian anyons and each gate of the path traversal gate sequence performed on the first sublattice is controlled by one or more ancilla qubits of the plurality of physical qubits.

In an example embodiment, the lattice is a Kagome lattice having periodic boundary conditions.

According to another aspect, a controller configured for creating, braiding, and fusing non-Abelian anyons is provided. In an example embodiment, the controller is configured to control operation of various components of a system, such as a confinement apparatus configured to confine a plurality of physical qubits and/or one or more manipulation sources configured to generate respective manipulation signals for interaction with respective physical qubits of the plurality of physical qubits. In an example embodiment, the controller is configured to perform controlling operation of the confinement apparatus to cause the plurality of physical qubits to be confined by the confinement apparatus. At least some qubits of the plurality of physical qubits are logically organized onto a lattice and have been prepared to provide a non-Abelian topological order ground state. The lattice comprises a plurality of vertices connected by edges. The lattice is formed of a plurality of sublattices, wherein each sublattice comprises a respective plurality of vertices of the plurality of vertices. The respective plurality of vertices of a sublattice of the plurality of sublattices are connected by edges to form the sublattice. The controller is further configured to perform causing performance of an anyon creation gate to cause creation of a first pair of non-Abelian anyons on a first sublattice of the plurality of sublattices; causing a path traversal gate sequence to be performed to cause at least a first anyon of the first pair of non-Abelian anyons to traverse a first braiding path to form a closed loop on the first sublattice; and determining a first fusion channel of fusing the first pair of non-Abelian anyons.

In an example embodiment, the anyon creation gate is an X-gate and causing generation of the first pair of non-Abelian anyons on the first sublattice comprises performing an X-gate on a creation location first vertex qubit of the first sublattice, the creation location first vertex qubit being a physical qubit of the plurality of physical qubits assigned to a vertex of the first sublattice that links a creation location of the first anyon of the first pair of non-Abelian anyons and a creation location of a second anyon of the first pair of non-Abelian anyons.

In an example embodiment, the path traversal gate sequence comprises a plurality of Pauli-X gates performed on vertices of the first sublattice along the braiding path and a plurality of controlled Z-gates each performed on a respective pair of physical qubits that includes a second vertex qubit and a third vertex qubit, wherein the second vertex qubit is a physical qubit of the plurality of physical qubits that is assigned to a vertex of the second sublattice and the third vertex qubit is a physical qubit of the plurality of physical qubits that is assigned to a vertex of the third sublattice.

In an example embodiment, the plurality of controlled Z-gates comprises controlled Z-gates performed on each third vertex qubit along the first braiding path with each preceding second vertex qubit along the first braiding path.

In an example embodiment, the controller is further configured to perform causing generation of a second pair of non-Abelian anyons on a second lattice of the plurality of sublattices, wherein performance of the path traversal gate sequence further causes at least a first anyon of the second pair of non-Abelian anyons to traverse a second braiding path to form a closed loop on the second sublattice so as to form a second fusion channel.

In an example embodiment, the first fusion channel is one of a plurality of possible fusion channels for the first pair of non-Abelian anyons and any crossings of the first braiding path and the second braiding path affects which fusion channel of the plurality of possible fusion channels is formed as the first fusion channel.

In an example embodiment, determining the first fusion channel comprises determining one or more expectation values for one or more operators defined on the lattice.

In an example embodiment, the controller is further configured to perform determining a creation location first vertex qubit and the first braiding path; and generating a set of machine level executable instructions for causing performance of the anyon creation gate and the path traversal gate sequence.

In an example embodiment, a gate used to create the first pair of non-Abelian anyons and each gate of the path traversal gate sequence performed on the first sublattice is controlled by one or more ancilla qubits of the plurality of physical qubits.

In an example embodiment, the lattice is a Kagome lattice having periodic boundary conditions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system configured for generating, braiding, and/or fusing non-Abelian anyons, in accordance with an example embodiment.

FIGS. 2A-2F provide a schematic diagrams illustrating operations performed to perform various steps of creating, braiding, and fusing a single pair of non-Abelian anyons, in accordance with an example embodiment.

FIG. 3 illustrates various operations defined on a lattice, in accordance with an example embodiment.

FIG. 4 schematically illustrates various processes and/or procedure for creating, braiding, and fusing non-Abelian anyons, in accordance with an example embodiment.

FIG. 5 schematically illustrates schematically illustrates various processes and/or procedure for creating, braiding, and fusing non-Abelian anyons in a Borromean loop, in accordance with an example embodiment.

FIG. 6 provides a flowchart illustrating various processes, procedures, and/or operations to cause creation, braiding, and fusing of non-Abelian anyons, in accordance with an example embodiment.

FIG. 7 provides a schematic diagram of an example controller of a system comprising a quantum object confinement apparatus configured for confining quantum objects therein, in accordance with an example embodiment.

FIG. 8 provides a schematic diagram of an example computing entity of a system comprising a quantum object confinement apparatus that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, quantum objects are confined by a quantum object confinement apparatus (also referred to as a confinement apparatus herein). In various embodiments, a quantum object is an ion; atom; ionic, molecular, and/or multipolar molecule; quantum dot; quantum particle; group, crystal, and/or combination thereof (e.g., an ion crystal comprising two or more ions); and/or the like. In an example embodiment where the quantum objects are ions and/or ion crystals, the confinement apparatus is an ion trap, such as a surface ion trap, Paul ion trap, and/or the like. In various other embodiments, the confinement apparatus is an apparatus configured to confine quantum objects.

In various embodiments, the quantum objects confined by a confinement apparatus are used to perform experiments, controlled quantum state evolution, quantum computations, and/or the like. In various embodiments, the quantum objects are transported between various locations at least partially defined by the confinement apparatus and/or a system comprising the confinement apparatus. For example, the confined quantum objects are physical qubits of a quantum processor including the confinement apparatus.

In various embodiments, the physical qubits are logically organized based on a lattice formed of a plurality of sublattices. In various embodiments, the sublattices are decouplable from one another, at least for some operations performed on the lattice. For example, for at least one operation defined on the lattice, the at least one operation only acts on physical qubits assigned to sites of one of a single sublattice and therefore the sublattices are decouplable with respect to the at least one operation. Thus, for portions of a circuit to be performed on the lattice that only include the at least one operation with respect to which the sublattices are decouplable, the sublattices may be treated as independent lattices. In an example embodiment, the plurality of sublattices includes three sublattices.

The lattice, in various embodiments is a Kagome lattice. A Kagome lattice is related to a trihexagonal tiling. A trihexagonal tiling is one of eleven uniform tilings of the Euclidean plane by regular polygons. A trihexagonal tiling consists of equilateral triangles and regular hexagons, arranged so that each hexagon is surrounded by triangles and vice versa. For example, two hexagons and two triangles alternate around each vertex, and its edges form an infinite arrangement of lines. The Kagome lattice consists of the vertices and edges of the trihexagonal tiling. For example, the lattice sites of the Kagome lattice are the vertices of the trihexagonal tiling, which are connected to one another by the edges of the trihexagonal tiling. In various embodiments where the lattice is a Kagome lattice, the sublattices are triangular lattices.

The term “logically organized” is used herein to indicate that the operational relationships between the plurality of physical qubits are determined based on and/or configured to conform to the lattice and the operations defined thereon. In at least one embodiment, the physical qubits of the plurality of physical qubits that form the lattice may be moved and/or transported independently of one another. Thus, the term “logically organized” is used herein to clarify that the plurality of physical qubits that form the lattice need not be physically organized based on the lattice. In particular, the interactions between the physical qubits of the lattice are governed, organized, and/or determined based on the lattice and the operations defined thereon. In various embodiments, the mobility of the physical qubits enables the arbitrary physical re-organizing of the physical qubits such that arbitrary physical qubit interactions are performable.

Complex quantum computations demand levels of precision that are not available in conventional quantum computers due to imperfect control and noise in gate operations between data qubits, for example. Proposed schemes for fault tolerant quantum computing include performing quantum computations on logical qubits that are logically organized based on a selected quantum error correction (QEC) code. Conventional quantum error correction includes the extraction of syndromes which generally includes the interaction of ancilla qubits with data qubits of a logical qubit defined by the QEC code. However, if not performed carefully, such interactions between ancilla qubits and data qubits can cause faults to spread ruinously, leading to logical errors that would have otherwise been correctable given their initial weight. Thus, technical problems exist regarding how to perform quantum computations with levels of precision that are sufficient for performing complex computations.

Various embodiments provide technical solutions to such technical problems. For example, various embodiments provide for the performance of fault tolerate quantum computing and/or fault tolerant quantum error correction using topological quantum computing. Topological quantum computing uses a phase of matter referred to as topological order to perform quantum computations. Topological order is a manifestation of long-range quantum entanglement of a plurality of quantum objects, such as the physical qubits. For example, a concentration of entanglement of the underlaying physical qubits forms a quasiparticle referred to as an anyon. For example, anyons are excitations of topological order (e.g., similar to how phonons are excitations of motional modes of matter). The trajectory of an anyon in four-dimensional spacetime is referred to as the anyon's worldline.

Various embodiments provide for the manipulation of anyons and/or a state of non-Abelian topological order. Non-Abelian topological order is a type of typological order having non-Abelian (e.g., non-commutative) properties. A result of the non-Abelian nature of such a state of matter results in the non-Abelian anyons “remembering” their respective histories. For example, performing Operation A and then performing Operation B on a non-Abelian anyon will provide a different result than performing Operation B and then performing Operation A on the non-Abelian anyon due to the non-commutativity of the non-Abelian topological order. For example, pairs of non-Abelian anyons may be generated and braided together. When the anyons are fused (e.g., when the pairs of non-Abelian anyons are brought back together), the resulting fusion channel will be dependent on how the braiding was performed. For example, when the braiding includes crossings of the worldlines of the anyons that are topologically non-trivial, those crossings cause a toggling of which fusion channel of the possible fusion channels for the fusion of a pair of anyons is created when the pair of anyons is fused. It is expected that these “memory” features of non-Abelian topological order will enable performance of fault tolerant quantum computing using non-Abelian anyons and/or various states of non-Abelian topological order.

Classical simulations are not able to simulate systems and/or matter exhibiting non-Abelian topological order. Therefore, in order to test whether these expectations of fault tolerant computing using non-Abelian topological order will come to bear, states of non-Abelian topological order must be generated and empirically investigated. However, conventional and experimentally successful techniques for the preparation and/or generation of states of non-Abelian topological order are not present in the art. Therefore, technical problems exist regarding the preparation and/or generation of states of non-Abelian topological order. Moreover, technical problems exist regarding determining whether and/or how topologically-protected quantum computing can provide for higher precision quantum computations.

Various embodiments provide technical solutions to these technical problems. For example, various embodiments provide methods, systems, controllers for systems, computer program products for configuring controllers of systems for manipulating states of a non-Abelian topological order. For example, in various embodiments, one or more pairs of non-Abelian anyons are created, braided, and fused using a plurality of physical qubits of a quantum processor, such as a QCCD-based processor. Various operations may be performed using the non-Abelian anyons.

However, technical problems exist regarding how to manipulate a state of non-Abelian topological order in a physical system. For example, technical problems exist regarding how to manipulate a state of non-Abelian topological order formed by the physical qubits of a trapped ion processor and/or a QCCD-based quantum processor. Various embodiments provide for generation and performance of quantum circuits for creating, braiding, and fusing non-Abelian anyons and, in some instances, determining one or more resulting fusion channels.

Therefore, various embodiments provide technical solutions to the technical problems regarding the manipulation of a state of non-Abelian topological order. Various embodiments therefore provide technical improvements to the fields of fault tolerant and/or topologically-protected quantum computing.

### Example System Configured for Manipulating States of Non-Abelian Topological Order

Various embodiments provide systems that are configured for manipulating states of non-Abelian topological order. For example, the system may be operated to create pairs of non-Abelian anyons, braid various anyons, and fuse the pairs of non-Abelian anyons to cause generation of fusion channels.

In various embodiments, the system includes a plurality of physical qubits. For example, in various embodiments, the system includes a confinement apparatus that confines a plurality of quantum objects that are used as the physical qubits. For example, in various embodiments the system is a QCCD-based quantum computing system, such as a QCCD-based processor, and/or the like. These systems may be configured for use in performing fault tolerant and/or topologically-protected quantum computing, and/or the like. In various embodiments, the system is configured for creating and/or making use of states of non-Abelian topological order and anyons. An example QCCD-based quantum computing system will now be disclosed.

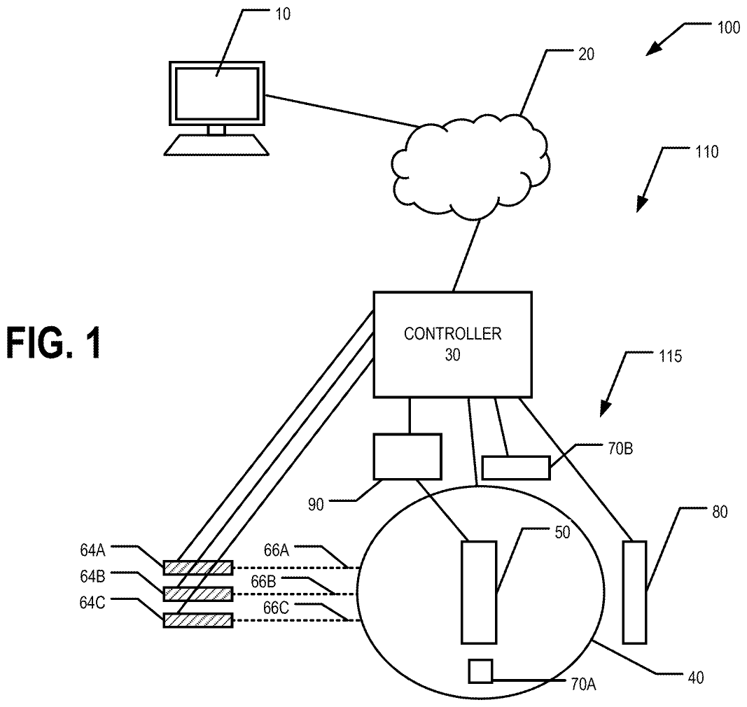

Various embodiments provide a system 100 comprising a quantum object confinement apparatus 50 (also referred to herein as a confinement operation), as shown in FIG. 1. The confinement apparatus 50 is configured to confine a plurality of quantum objects such that the respective quantum states of the quantum objects may be manipulated, evolved in a controlled manner (e.g., in accordance with a quantum circuit), and/or the like.

For example, quantum operation functions (one qubit quantum gates, two-qubit quantum gates, initialization, reading and/or measurement operations, and/or the like) may be performed on quantum objects disposed within quantum operation locations defined by the confinement apparatus 50 and/or system 100 comprising the confinement apparatus. For example, the confinement apparatus 50 is configured to maintain one or more quantum objects at a quantum operation location such that the quantum operation may be performed on the one or more quantum objects. For example, the quantum objects confined by the confinement apparatus 50 are used as the physical qubits of the system 100.

In various embodiments, the system 100 comprising the confinement apparatus 50 comprises one or more manipulation sources 64 (e.g., 64A, 64B, 64C) configured to provide manipulation signals (e.g., laser beams and/or pulses, microwave signals, and/or the like) such that the manipulation signals interact with one or more quantum objects disposed at respective quantum operation locations. In various embodiments, the system 100 comprising the confinement apparatus 50 comprises one or more magnetic field sources 70 (e.g., 70A, 70B) configured to provide a controlled magnetic field and/or magnetic field gradient at quantum operation locations for use in performing one or more quantum operations on one or more quantum objects disposed at the quantum operation locations. In various embodiments, the system 100 comprising the confinement apparatus 50 comprises an optical collection system 80 configured to collect and/or detect light and/or photons emitted (e.g., fluoresced) by one or more quantum objects disposed at respective quantum operation locations.

In an example embodiment, the system 100 comprising the confinement apparatus 50 is and/or includes a quantum charge-coupled device (QCCD)-based quantum computer. For example, one or more of the quantum objects confined by the confinement apparatus 50 may be used as physical qubits of the quantum computer.

In various embodiments, the system 100 comprises a computing entity 10 and a quantum computer 110. In various embodiments, the quantum computer 110 comprises a controller 30 and a quantum processor 115. In various embodiment, the quantum processor 115 comprises a cryostat and/or vacuum chamber 40 enclosing a confinement apparatus 50, one or more manipulation sources 64 (e.g., 64A, 64B, 64C), one or more voltage sources 90, one or more magnetic field sources 70 (e.g., 70A, 70B), an optical collection system 80, and/or the like. In various embodiments, the controller 30 is configured to control the operation of (e.g., control one or more drivers configured to cause operation of) the manipulation sources 64, voltage sources 90, magnetic field sources 70, a vacuum system and/or cryogenic cooling system (not shown), and/or the like. In various embodiments, the controller 30 is configured to receive signals (e.g., electrical signals) generated and provided by the optical collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more quantum objects confined by the confinement apparatus 50. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/measurement, and/or like) on quantum objects confined by the confinement apparatus 50.

In an example embodiment, the one or more manipulation sources 64 each provide a manipulation signal (e.g., laser beam and/or the like) to one or more portions (e.g., quantum operation locations) of the confinement apparatus 50 via corresponding beam path systems 66 (e.g., 66A, 66B, 66C). In various embodiments, at least one beam path system 66 comprises a modulator configured to modulate the manipulation signal being provided to the confinement apparatus 50 via the beam path system 66. In various embodiments, the manipulation sources 64, active components of the beam path systems 66 (e.g., modulators and/or the like), and/or other components of the quantum computer 110 are controlled by the controller 30.

In various embodiments, the confinement apparatus 50 is an ion trap, such as a surface ion trap, Paul ion trap, and/or the like. In various embodiments, the quantum objects are ions; atoms; ion crystals and/or groups; atomic crystals and/or groups; ionic, molecular, and/or multipolar molecules; quantum dots; quantum particles; groups, crystals, and/or combinations thereof (e.g., ion crystals); and/or the like. In various embodiments, the confinement apparatus 50 is an appropriate confinement apparatus for confining the quantum objects of the embodiment. In various embodiments, the confinement apparatus 50 is similar to the confinement apparatuses and/or ion traps disclosed in U.S. application No. Ser. No. 17/810,082, filed Jun. 30, 2022, U.S. Pat. No. 11,037,776, issued Jun. 15, 2021, U.S. application Ser. No. 17/533,587, filed Nov. 23, 2021, and/or U.S. Application No. 63/500,710, filed May 8, 2023.

In various embodiments, the quantum computer 110 comprises one or more voltage sources 90. For example, the voltage sources may be arbitrary wave generators (AWG), digital-analog converts (DACs), direct digital synthesizers (DDSs), and/or other voltage signal generators. For example, the voltage sources 90 may comprise a plurality of control voltage drivers and/or voltage sources and/or at least one RF driver and/or voltage source. The voltage sources 90 may be electrically coupled to the corresponding potential generating elements (e.g., control electrodes and/or RF electrodes) of the confinement apparatus 50, in an example embodiment.

In various embodiments, the voltage signals generated by the voltage sources 90 are filtered before being applied to the potential generating elements (e.g., control electrodes and/or RF electrodes) of the confinement apparatus 50. In an example embodiment, the system 100 comprises filters configured to filter the voltage signals generated by the voltage sources 90 and applied to the electrodes of the confinement apparatus 50.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more locations defined by the confinement apparatus 50 that has a particular magnitude and a particular magnetic field direction in the one or more locations defined by the confinement apparatus 50.

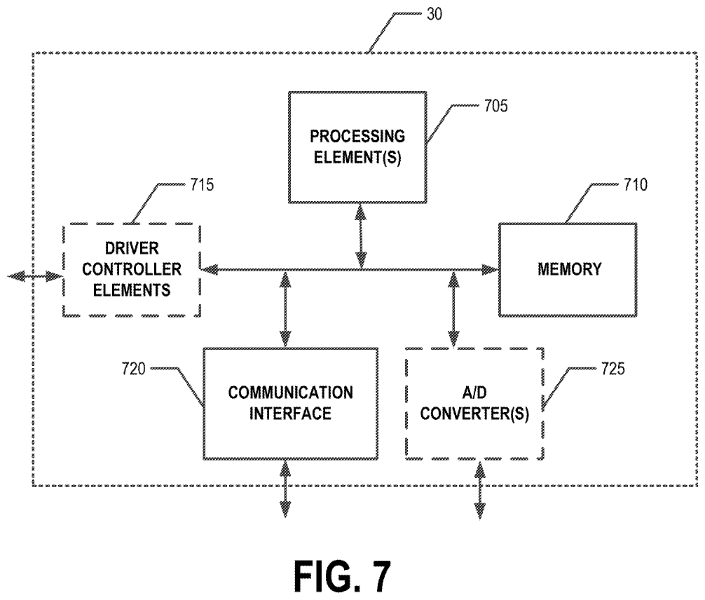

In various embodiments, the quantum computer 110 comprises an optical collection system 80 configured to collect and/or detect photons (e.g., stimulated emission) generated by quantum objects disposed in respective quantum operation locations (e.g., during reading/measurement operations). The optical collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the quantum objects. In various embodiments, the detectors may be in electronic communication with the controller 30 via one or more A/D converters 725 (see FIG. 7) and/or the like.

In various embodiments, a computing entity 10 is configured to allow a user to provide input to the quantum computer 110 (e.g., via a user interface of the computing entity 10) and receive, view, and/or the like output from the quantum computer 110. For example, a user may operate a (classical and/or semiconductor-based) computing entity 10 to generate a quantum program and/or circuit and the computing entity 10 may provide the quantum program and/or circuit and/or a compiled version thereof to the controller 30 of the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control operation of the voltage sources 90, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more quantum objects within the confinement apparatus 50, and/or read and/or measure a quantum (e.g., qubit) state of one or more quantum objects within the confinement apparatus. For example, the controller 30 may cause a controlled evolution of quantum states of one or more quantum objects confined by the confinement apparatus 50 to execute a quantum circuit and/or algorithm. For example, the controller 30 may cause entanglement of one or more quantum objects confined by the confinement apparatus 50 to prepare and/or generate a ground state or excited state of a non-Abelian topological order. For example, the controller 30 may read and/or detect quantum states of one or more quantum objects within the confinement apparatus 50 at one or more points during the execution of a quantum circuit. In various embodiments, the quantum objects confined by the confinement apparatus are used as qubits of the quantum computer 110.

### Example Creation, Braiding, and Fusing of Non-Abelian Anyons

In various embodiments, a lattice is defined that includes a plurality of vertices that are connected by respective edges. In an example embodiment, the lattice is a Kagome lattice. Physical qubits of the quantum processor 115 are assigned to respective vertices of the lattice so as to logically organize the physical qubits based on the lattice. The vertices of the lattice are colored so as to define a plurality of sublattices that are decouplable with respect to at least one operation defined on the lattice. For example, in an example embodiment, the lattice is colored with three colors. The lattice is defined with periodic boundaries such that the lattice is formed on a torus.

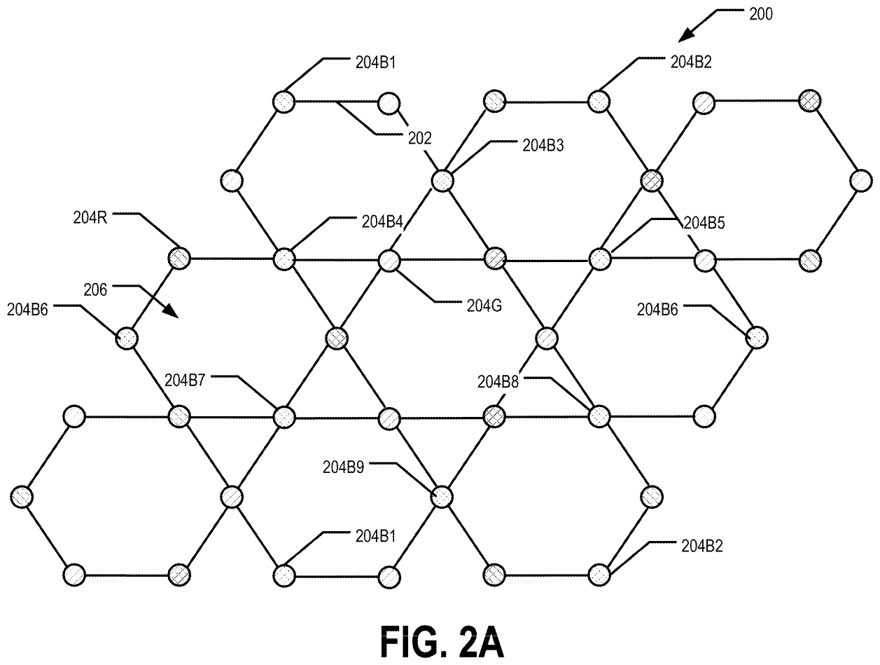

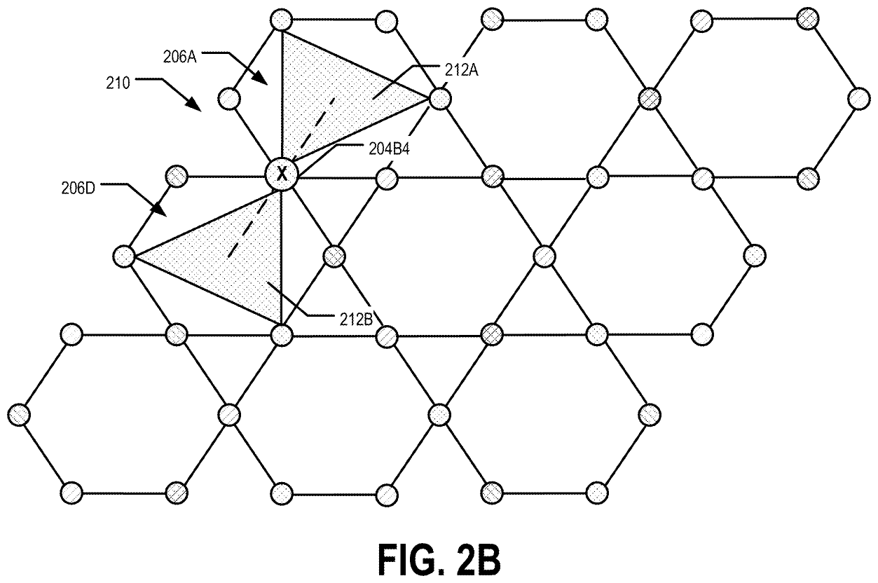

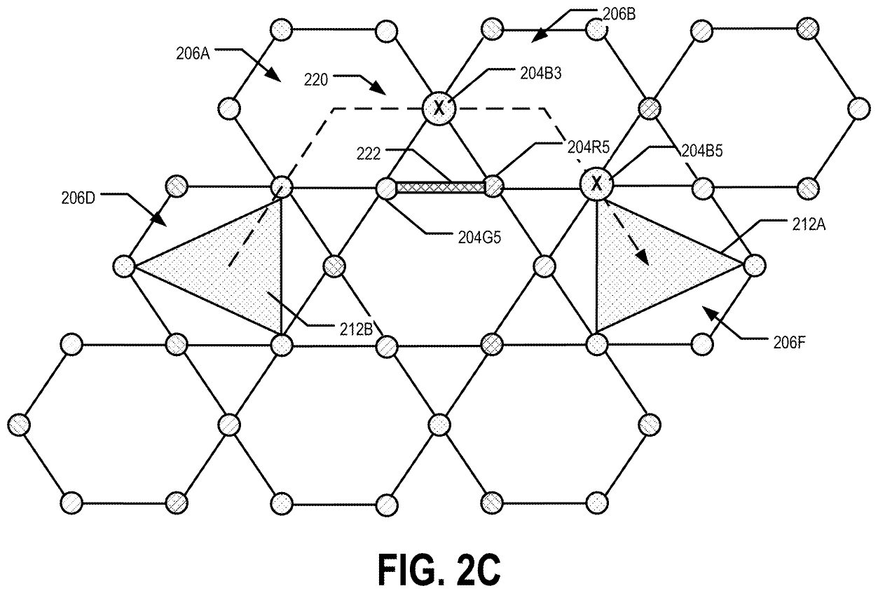

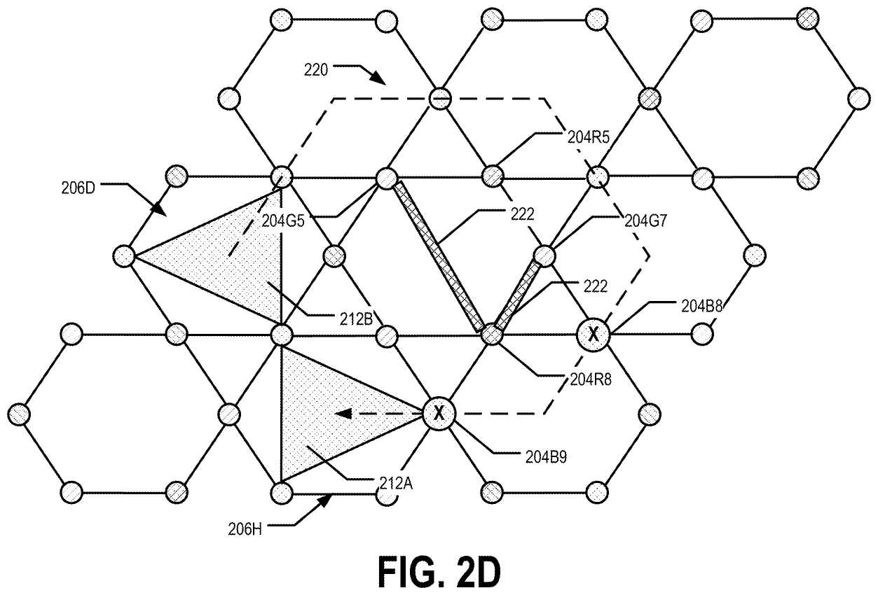

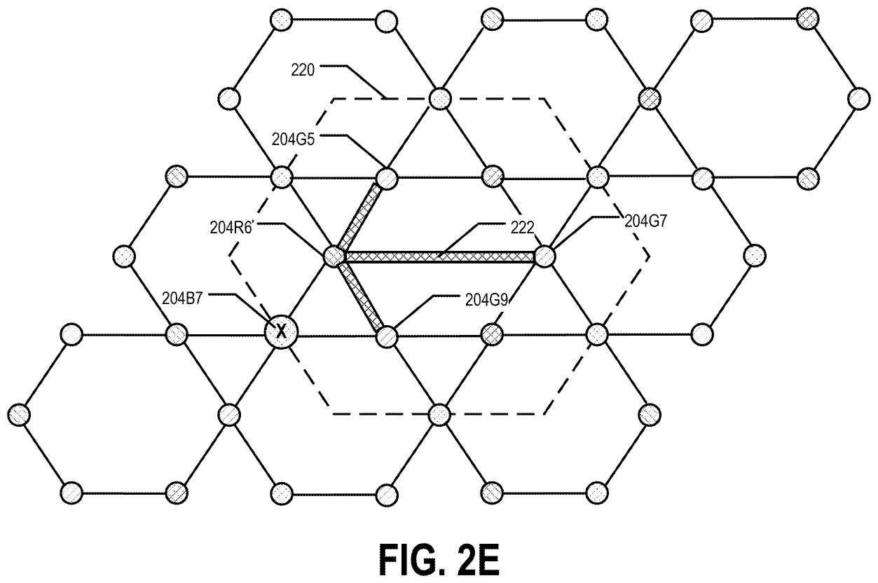

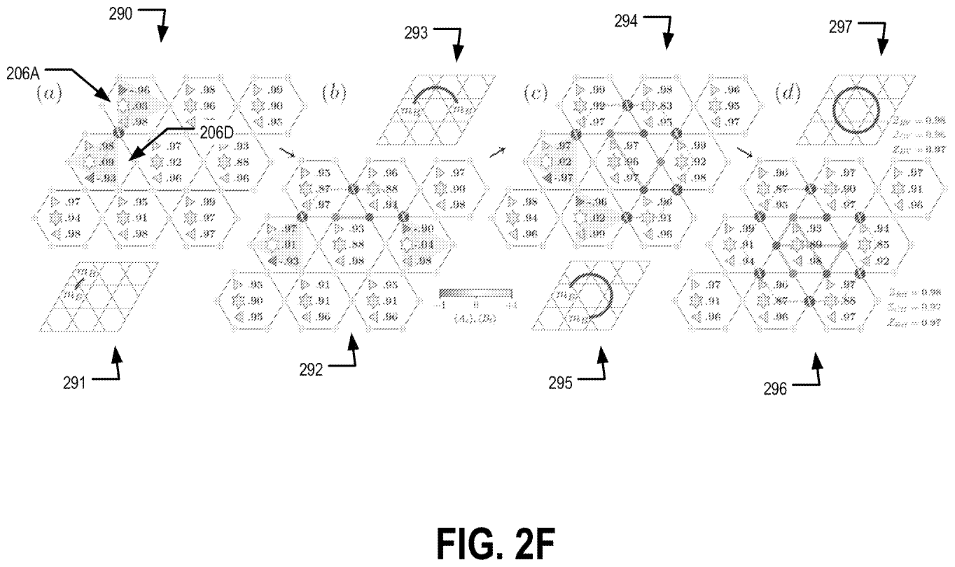

FIG. 2A illustrates an example lattice 200. The lattice 200 is formed by a plurality of vertices 204 (e.g., 204B, 204G, 204R) that are linked by respective edges 202. The illustrated lattice 200 includes three sublattices. A first sublattice of a first “color” includes a first set of vertices 204B1-204B9, a second sublattice of a second “color” includes a second set of vertices 204G, and a third sublattice of a third “color” includes a third set of vertices 204R. In various embodiments, physical qubits of the quantum processor 115 are assigned to respective vertices 204 of the lattice. In various embodiments, the lattice defines a plurality of plaquettes 206. In general, a plaquette is the smallest closed loop, enclosing the region between four lattice sites.

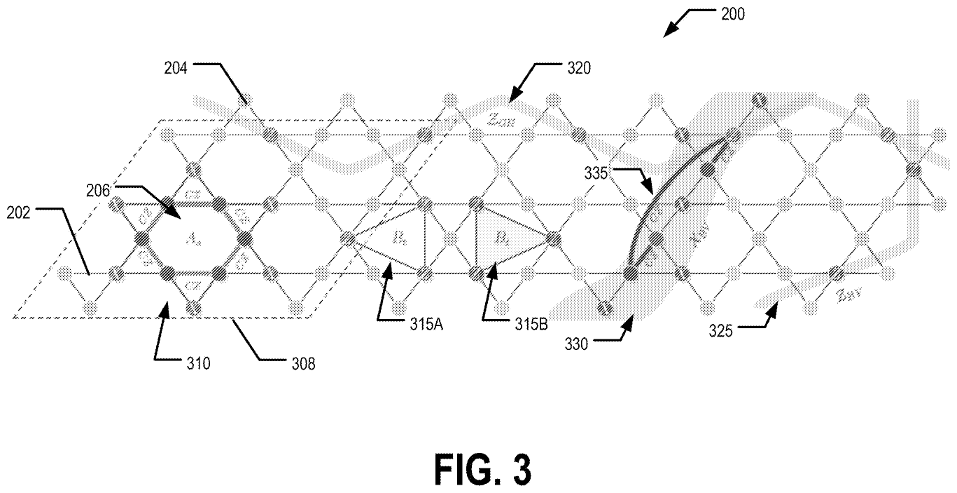

As shown in FIG. 3, various operations are defined on the lattice 200. Each plaquette supports one star operator 310 and two triangle operators 315A, 315B. For example, star operator 310 is an operator that works on twelve sites. As illustrated, the star operator 310 enacts operator

$${A}_{S} = {\prod }_{i = 1}^{6} C {Z}_{i , i + 1} {X}^{⊗ 6} , {CZ}_{i , i + 1}$$

is a controlled Z-gate between adjacent sites around the hexagon of the particular star and X^{⊗6} is the product of X-gates (e.g., Pauli-X gates) performed on each of the six points of the particular star (e.g., X₁⊗X₂⊗X₃⊗X₄⊗X₅⊗X₆). A single instance of a star operator 310 acts on lattice sites of multiple colors (e.g., all three of the first color, second color, and third color, in the illustrated embodiment). A triangle operator 315 may point in either direction (e.g., left or right) across the hexagon of a plaquette. Thus, while a plaquette supports one star operator 310, each plaquette supports two triangle operators 315. The three-site triangle operator 315 enacts operator B_{T}=Z^{⊗3}=Z₁⊗Z₂⊗Z₃ or the product of Z-gates performed on the three sites acted upon by the triangle operator 315. A single instance of the triangle operator 315 acts on lattice sites of a single color. As a result, the sublattices are decouplable with respect to the triangle operator 315.

The Hamiltonian of qubits arranged on a periodic Kagome lattice giving rise to non-Abelian topological order is

$$H = - {A}_{S} - {B}_{T} ,$$

where { [symbol] } is the set of stars on the periodic Kagome lattice and { [symbol] } is the set of triangles on the periodic Kagome lattice. A ground state of the non-Abelian order satisfies A_{S}=B_{T}=1.

Additionally, for each color of the lattice and each direction (e.g., vertical, horizontal) along the torus, two logical string operators are defined. The logical Z-operators are products of local Pauli-Z gates acting on all the lattice sites (e.g., the physical qubits assigned to the lattice sites) of a respective color in a chosen direction. For example, FIG. 3 illustrates the logical horizontal green Z-operator [symbol] _{GH} and the logical vertical blue Z-operator [symbol] _{BV}. The logical X-operators, of which the logical vertical blue X-operator χ_{BV} is shown in FIG. 3, is a product of local Pauli-X gates with a series of controlled Z gates that connect every green vertex with preceding red vertices on the path in the chosen direction.

In various embodiments, the physical qubits are prepared in a ground state of non-Abelian topological order. An example process for preparing the physical qubits in a ground state of non-Abelian topological order is disclosed by U.S. application No. Ser. No. 18/635,403, filed Apr. 15, 2024, the content of which is incorporated herein by reference in its entirety.

Once the physical qubits are prepared in a ground state of non-Abelian topological order, the state of the non-Abelian topological order may be manipulated to cause creation of pairs of non-Abelian anyons, braiding of the non-Abelian anyons, and/or fusion of pairs of non-Abelian anyons resulting in fusion channels being created on the lattice 200. For example, FIG. 2A illustrates the lattice 200 in a ground state of the non-Abelian topological order (e.g., with no excitations/anyons present on the lattice).

FIG. 2B illustrates the creation of a pair of non-Abelian anyons 210 with a first anyon 212A of the pair at the first plaquette 206A and the second anyon 212B of the pair at a fourth plaquette 206D of the lattice 200. The pair of non-Abelian anyons 210 is created by applying an anyon creation gate to a vertex qubit assigned to vertex 204B4. In various embodiments, the anyon creation gate is an X-gate (e.g., a Pauli X-gate). For example, the first and second anyons 212A, 212B are represented on the lattice 200 as triangles of the first sublattice with one facing to the right and the other facing to the left. In particular, as shown in panel 290 of FIG. 2F, creation of the pair of non-Abelian anyons 210 on the first and fourth plaquettes 206A, 206D causes the respective triangle operators of the first and fourth plaquettes 206A, 206D to have a value of approximately negative one, rather than positive one. The values within each plaquette 206 indicate the expectation values of the triangle and star operators on that plaquette. Panel 291 illustrates a 2D projection of the worldline of the pair of non-Abelian anyons 210.

By performing the anyon creation gate on the vertex qubit assigned to vertex 204B4, the expectation values of the right facing triangle operator on the first plaquette 206A and of the left facing triangle operator on the fourth plaquette 206D have been toggled from approximately +1 to approximately −1. Additionally, the expectation value of the star operator on the first and fourth plaquettes 206A, 206D has changed from approximately 1 to approximately zero. This excitation of the ground state of non-Abelian topological order gives rise to the pair of non-Abelian anyons 210 at locations that are linked via the vertex qubit on which the anyon creation gate was performed.

FIG. 2C illustrates the pair of non-Abelian anyons 210 after the first anyon 212A has traversed a first portion of a braiding path 220. For example, the first anyon has been transported from the first plaquette 206A to the sixth plaquette 206F of the lattice 200. To cause the first anyon 212A to traverse the portion of the braiding path 220, a path traversal gate sequence is performed on vertex qubits along the braiding path. In various embodiments, a path traversal gate sequence is a sequence of single and/or two-qubit gates that causes an anyon to traverse at least a portion of a braiding path.

For example, performing the path traversal gate sequence for the illustrated portion of the braiding path 220 shown in FIG. 2C includes performing an X-gate (e.g., a Pauli X-gate) on the vertex qubit assigned to vertex 204B3 and another X-gate is performed on the vertex qubit assigned to vertex 204B5. Additionally, performing the path traversal gate sequence for the illustrated portion of the braiding path 220 shown in FIG. 2C includes performing a controlled Z-gate (CZ-gate) 222 on the vertex qubits assigned to vertices 204R5 and 204G5. In various embodiments, the X-gate is performed prior to the CZ-gate 222, the X-gate and the CZ-gate are performed simultaneously, or the CZ-gate is performed prior to the X-gate. For example, X-gates are performed on the vertex qubits assigned to vertices of the first sublattice (the same sublattice on which the pair of anyons 210 were generated) along the braiding path 220. A CZ-gate is performed on each vertex qubit assigned to a vertex of the third sublattice that is located along the braiding path 220 and each vertex qubit assigned to a preceding vertex of the second sublattice along the braiding path 220.

Panel 292 of FIG. 2F illustrates the expectation values of the triangle and star operators on each of the plaquettes 206 of the lattice 200 when the first anyon 212A is disposed at the sixth plaquette 206F. Panel 293 illustrates the 2D projection of the worldline of the first pair of anyons 210 while the first anyon 212A is disposed at the sixth plaquette 206F.

FIG. 2D illustrates the pair of non-Abelian anyons 210 after the first anyon 212A has traversed a second portion of the braiding path 220 such that the first anyon 212A is disposed at the eighth plaquette 206H. The first anyons 212A is caused to traverse the second portion of the braiding path 220 by performance of a corresponding path traversal gate sequence. For example, the path traversal gate sequence comprises X-gates on the vertex qubits assigned to vertices of the first sublattice along the second portion of the braiding path 220 (e.g., vertices 204B8 and 204B9) and CZ-gates 222 on the vertex qubit assigned to a vertex of the third sublattice that is disposed along the second portion of the braiding path 220 and the preceding vertices of second sublattice disposed along the braiding path 220. For example, a CZ-gate is performed on the vertex qubits assigned to vertices 204R8 and 204G5 and another CZ-gate is performed on the vertex qubits assigned to vertices 204R8 and 204G7.

For example, the excitation of the non-Abelian topological order referred to herein as the first anyon 212A is transported through the lattice 200 along the braiding path 220 by performing X-gates on the vertex qubits assigned to vertices of the first sublattice along the braiding path 220 and by performing CZ-gates on the vertex qubits assigned to each of the vertices of the third sublattice along the braiding path 220 with vertex qubits assigned to each preceding vertex of the second sublattice along the braiding path 220 (e.g., disposed within the loop formed by the braiding path 220).

Panel 294 of FIG. 2F illustrates the expectation values of the triangle and star operators on each of the plaquettes 206 of the lattice 200 when the first anyon 212A is disposed at the eighth plaquette 206H. Panel 295 illustrates the 2D projection of the worldline of the first pair of anyons 210 while the first anyon 212A is disposed at the eighth plaquette 206H.

FIG. 2E illustrates the operations performed to cause the first anyon 212A to finish traversing the braiding path 220 such that the braiding path 220 forms a closed loop. When the first anyon 212A closes the loop of the braiding path 220, the first anyons 212A and the second anyon 212B fuse to produce a fusion channel. In this example, because the topology of the braiding path 220 is trivial, the fusion channel is the identity channel. In other words, in this topologically trivial example, the lattice 200 returns to the ground state it was in prior to the formation of the pair of anyons 210 when the pair of anyons 210 fuse.

To cause the first anyon 212A to finish traversing the braiding path 220, a path traversal gate sequence is performed that includes an X-gate performed on the vertex qubit assigned to the final vertex along the braiding path 220 (e.g., vertex 204B7) and CZ-gates performed on the vertex qubits assigned to each of the vertices of the third sublattice along the braiding path 220 with vertex qubits assigned to each preceding vertex of the second sublattice along the braiding path 220 (e.g., disposed within the loop formed by the braiding path 220). For example, CZ-gates 222 are performed on the physical qubits assigned to vertices 204R6 with 204G5, vertices 204R6 with 204G7, and vertices 204R6 with 204G9.

Panel 296 of FIG. 2F illustrates the expectation values of the triangle and star operators on each of the plaquettes 206 of the lattice 200 when the first anyon 212A and the second anyon 212B have been fused. For example, as shown in panel 297, the 2D projection of the worldline of the first pair of anyons 210 forms a closed loop when the first anyon 212A has finished traversing the braiding path 220.

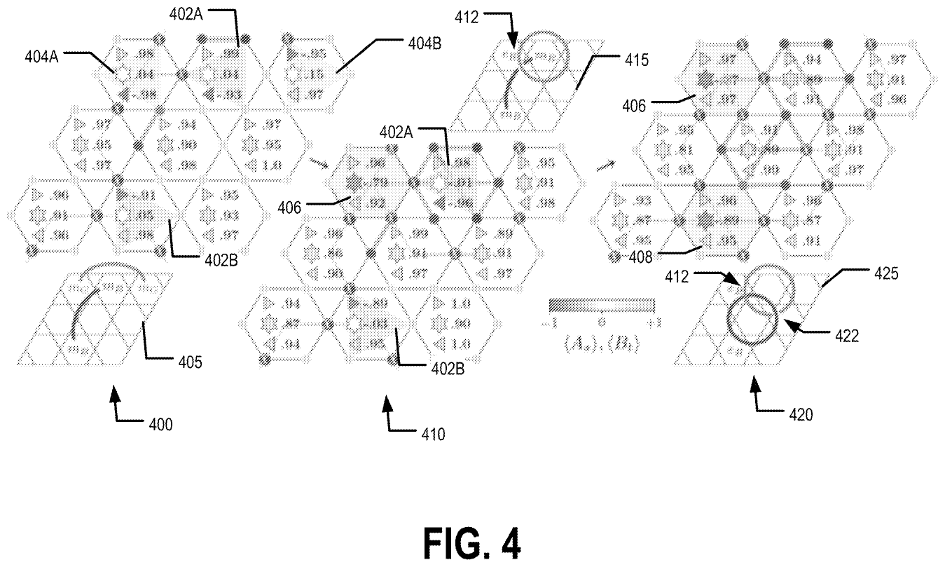

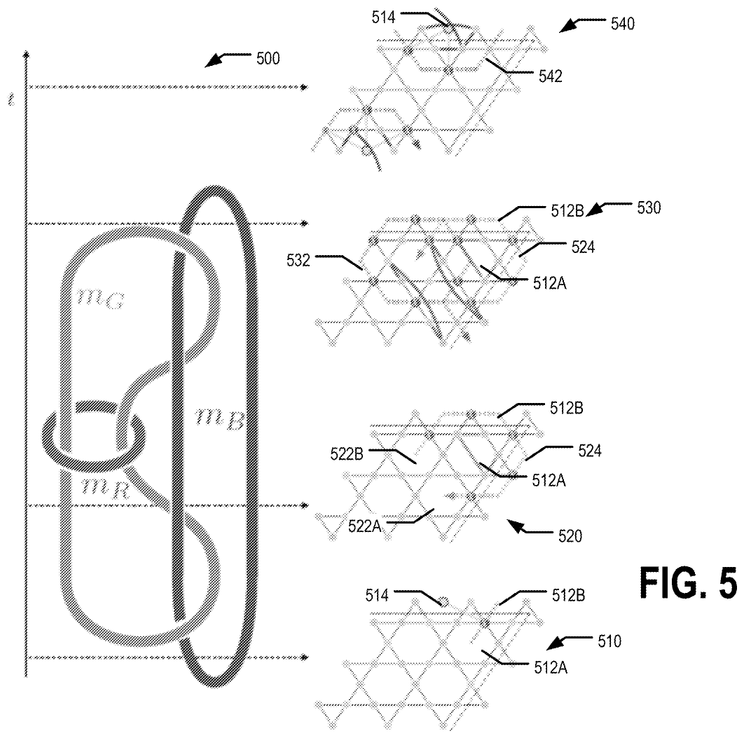

FIG. 4 provides an example of creating pairs of non-Abelian anyons, braiding the non-Abelian anyons in a topological non-trivial manner, and fusing the pairs of non-Abelian anyons to form fusion channels. Panel 400 corresponding to a first time illustrates a first pair of non-Abelian anyons (first anyon 402A and second anyon 402B) created on the first sublattice and a second pair of non-Abelian anyons (first anyon 404A and second anyon 404B) created on the second sublattice. For example, the pairs of anyons are created similar to as described with respect to the first pair of anyons 210 shown in FIG. 2B. For example, an anyone creation gate (e.g., an X-gate) may be performed on a vertex qubit assigned to a vertex of a respective sublattice to cause a pair of anyons to be formed on the respective sublattice at locations that are linked by the vertex. The 2D projection 405 of the worldlines of the first and second pair of anyons shows that the worldlines of the first and second pair of anyons have not yet crossed.

Panel 410, corresponding to a second time, illustrates that a point in time after the second pair of non-Abelian anyons (first anyon 404A and second anyon 404B) has completed traversal of a braiding path such that the second pair of non-Abelian anyons has fused. For example, the second anyon 404B of the second pair of non-Abelian anyons is caused to traverse a respective braiding path via performance of a path traversal gate sequence (e.g., X-gates on vertex qubits assigned to vertices of the second sublattice along the braiding path and CZ-gates on physical qubits assigned to vertices of the first sublattice and each preceding vertex of the third sublattice along the braiding path (e.g., within the loop of the braiding path)).

As shown in the 2D projection 415 of the worldlines of the first and second pairs of non-Abelian anyons, the worldline of the second pair of non-Abelian anyons crossed over the worldline of the first pair of non-Abelian anyons at crossing 412. As a result of the crossing 412, the fusion channel of the second pair of non-Abelian anyons has been toggled from the identity channel to another channel—an anyon 406 on the third sublattice.

Panel 420, corresponding to a third time, illustrates a point in time after the first pair of non-Abelian anyons (first anyon 402A and second anyon 402B) has completed traversal of a braiding path such that the first pair of non-Abelian anyons has fused. For example, the first anyon 402A of the first pair of non-Abelian anyons is caused to traverse a respective braiding path via performance of a path traversal gate sequence (e.g., X-gates on vertex qubits assigned to vertices of the first sublattice along the braiding path and CZ-gates on physical qubits assigned to vertices of the third sublattice and each preceding vertex of the second sublattice along the braiding path (e.g., within the loop of the braiding path)).

In various embodiments, when a non-Abelian anyon of the first sublattice is transported along a braiding path, a path traversal gate sequence includes X-gates performed on the vertex qubits assigned to vertices of the first sublattice located along the braiding path and CZ-gates performed on physical qubits assigned to vertices of the third sublattice along the braiding path (e.g., within the loop of the braiding path) with each preceding vertex of the second sublattice along the braiding path (e.g., within the loop of the braiding path). When a non-Abelian anyon of the second sublattice is transported along a braiding path, a path traversal gate sequence includes X-gates performed on the vertex qubits assigned to vertices of the second sublattice located along the braiding path and CZ-gates performed on physical qubits assigned to vertices of the first sublattice along the braiding path (e.g., within the loop of the braiding path) with each preceding vertex of the third sublattice along the braiding path (e.g., within the loop of the braiding path). When a non-Abelian anyon of the third sublattice is transported along a braiding path, the path traversal gate sequence includes X-gates performed on the vertex qubits assigned to vertices of the third sublattice located along the braiding path and CZ-gates performed on physical qubits assigned to vertices of the second sublattice along the braiding path (e.g., within the loop of the braiding path) with each preceding vertex of the first sublattice along the braiding path (e.g., within the loop of the braiding path).

As shown in the 2D projection 425 of the worldlines of the first and second pairs of non-Abelian anyons, the worldline of the first pair of non-Abelian anyons has crossed over the worldline of the second pair of non-Abelian anyons at crossing 422. As a result of the crossing 422, the fusion channel of the first pair of non-Abelian anyons has been toggled from the identity channel to another channel—an anyon 408 on the third sublattice.

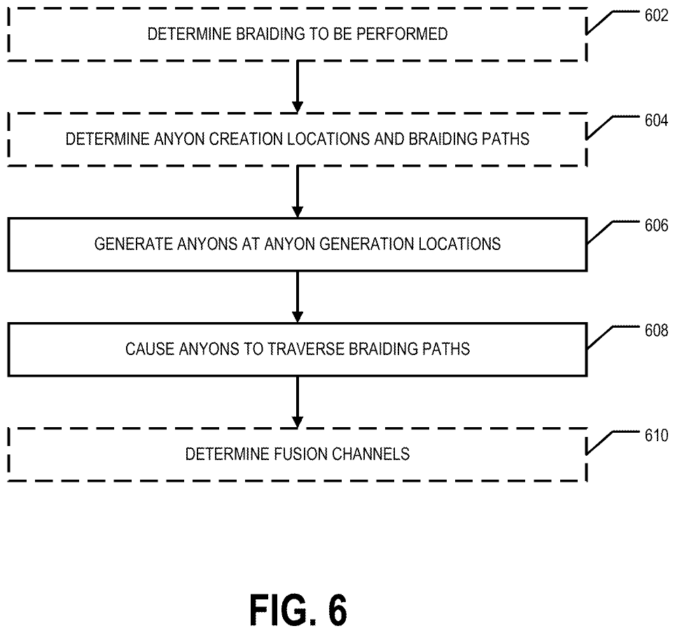

FIG. 6 illustrates another example non-trivial braiding of non-Abelian anyons that is a Borromean braiding in spacetime. First, second, and third pairs of anyons are created with pair on on each sublattice such that each pair is unlinked. The pairs of anyons are then caused to traverse respective braiding paths such that the worldlines of the pairs of anyons form Borromean rings. The defining property of Borromean rings is that any pair of rings is unlinked such that the removal of any one ring renders the diagram topologically trivial.

Plot 500 illustrates the worldlines of three pairs of non-Abelian anyons m_{B}, m_{G}, m_{R} with the vertical axis corresponding to time. For example, at a first time, as shown in panel 510, a first pair of non-Abelian anyons 512A, 512B is created. The generation and movement of the first pair of anyons is controlled by an ancilla qubit 514. For example, rather than using a single qubit anyon creation gate (e.g., a single qubit X-gate) to generate the first pair of non-Abelian anyons, a two-qubit controlled anyon creation gate (e.g., a controlled X-gate) is performed with the ancilla controlling the gate. For example, a physical qubit of the plurality of qubits confined by the confinement apparatus 50 may be assigned to be an ancilla qubit 514 (e.g., rather than a vertex qubit). The ancilla qubit may then be used to control the gates used to create, braid, and fuse the first pair of non-Abelian anyons.

In various embodiments, the ancilla qubit of the controlled X-gate is used to perform a Hadamard test. For example, a Hadamard test may be used to measure non-Hermitian observables. For example, a Hadamard test may be used to determine the value of a phase φ corresponding to the action of a unitary operator U acting on a quantum state ψ such that <ψ|U|ψ>=e^{-iφ}, where e is Euler's number and i is the square root of negative one.

At a second time, as shown in panel 520, a second pair of non-Abelian anyons 522A, 522B is created and caused to traverse a first portion of a braiding path 524. As the first anyon 522A of the second pair of non-Abelian anyons traverses the first portion of the braiding path 524, the worldline of the first anyon 522A of the second pair of non-Abelian anyons crosses the worldline of the first pair of non-Abelian anyons. The thick lines illustrate the CZ-gates performed to cause the first anyon 522A of the second pair of non-Abelian anyons to traverse the braiding path 524. The X's on the vertices indicate which vertex qubits have the X-gates applied thereto to cause the first anyon 522A of the second pair of non-Abelian anyons to traverse the braiding path 524.

Panel 530 illustrates a snapshot of the topological order at a third time. Between the second time and third time, a third pair of non-Abelian anyons was generated, caused to traverse a braiding path 532 that crossed the worldline of the second pair of non-Abelian anyons twice, and were fused. Also between the second time and the third time, the second pair of non-Abelian anyons traversed a second portion of the braiding path 524 such that the worldline of the second pair of anyons crossed back over the worldline of the first pair of non-Abelian anyons (after the worldline of the third pair of non-Abelian anyons crossed the worldlines of the second pair of non-Abelian anyons for the second time) and then the second pair of non-Abelian anyons were caused to fuse.

Panel 540 illustrates a snapshot of the topological order at a fourth time. Between the third time and the fourth time, the first pair of non-Abelian anyons is caused to traverse a braiding path 542. As the first pair of non-Abelian anyons traverse the braiding path 542, the ancilla qubit 514 is used in performance of a controlled path traversal gate sequence. For example, in the illustrated embodiment, the ancilla qubit 514 is used to control the X-gates performed on the vertex qubits assigned to the vertices of the first sublattice.

FIG. 6 provides a flowchart illustrating various processes, procedures, operations, and/or the like performed by a controller 30, for example, of a QCCD-based quantum computer 110 to manipulate a state of non-Abelian topological order formed using physical qubits of the QCCD-based quantum computer. For example, the controller 30 may control operation of various components of the QCCD-based quantum computer to cause the creation, braiding, and fusing of non-Abelian anyons. For example, the controller 30 may generate or receive a quantum circuit to be performed using the physical qubits of the QCCD-based quantum computer 110 to cause the creation, braiding, and fusing of pairs of non-Abelian anyons. For example, physical qubits of the QCCD-based quantum computer 110 may be logically organized onto a lattice and prepared into a ground state of a non-Abelian topological order. The controller 30 may then control operation of various components of the QCCD-based quantum computer to manipulate the state of the non-Abelian topological order.

Starting at 602, the controller 30 determines a braiding to be performed. For example, the controller 30 comprises means, such as processing element 705, memory 710, communication interface 720, and/or the like (e.g., as illustrated in FIG. 7), for determining a braiding to be performed. For example, the controller 30 may receive a quantum circuit and/or quantum program generated and provided (e.g., transmitted) by the classical computing entity 10 and the quantum circuit and/or quantum program may indicate a braiding to be performed. In another example, the controller 30 may be controlling operation of QCCD-based quantum processor 115 to cause the QCCD-based quantum processor 115 to perform at least a first portion of a quantum circuit and/or quantum program. Based on a result of performing the first portion of the quantum circuit and/or quantum program, the controller 30 may determine a braiding to be performed. For example, the braiding to be performed may correspond to a computation to be performed.

At step 604, the controller 30 determines anyon creation locations and braiding paths. For example, the controller 30 comprises means, such as processing element 705, memory 710, communication interface 720, and/or the like, for determining anyon creation locations and braiding paths. For example, based on the braiding to be performed, the controller 30 determines at which locations within the lattice to create pairs anyons and braiding paths for the pairs of anyons such that when the pairs of anyons traverse the braiding paths the desired braiding is performed. For example, the controller 30 may determine the anyon creation locations and braiding paths based at least in part on the by braiding to be performed.

In various embodiments, the controller 30 generates a quantum circuit indicating gates, measurement operations, and/or the like to be performed on physical qubits of the quantum processor 115. For example, performance of sequence of single and/or two-qubit gates on the physical qubits of the quantum processor 115 causes the creation, braiding, and fusing of the non-Abelian anyons of the non-Abelian topological order formed using the physical qubits. For example, for the creation of a non-Abelian anyon on a particular sublattice, a vertex qubit assigned to a vertex that links the creation locations of a pair of non-Abelian anyons is identified and a quantum circuit is generated that includes performance of an anyone creation gate (e.g., X-gate) on the vertex qubit at an appropriate time during the quantum circuit to cause creation of the pair of non-Abelian anyons at the creation locations. For example, if the determined braiding paths indicate a path along which a first non-Abelian anyon of the created pair of non-Abelian anyons should be transported from the creation location to a second location, a path traversal gate sequence of gates (e.g., X-gates on vertex qubits of the particular sublattice and CZ-gates on appropriate pairs of vertex qubits in the sublattices that are not the particular sublattice) are added to the quantum circuit.

The quantum circuit may be built to include creation of each pair of anyons and corresponding braiding path corresponding to the determined braiding to be performed. For example, a quantum circuit is built by mapping anyon creation gates and path traversal gate sequences to particular physical qubits of the quantum processor based on the determined anyon creation locations and braiding paths. The quantum circuit may further be built to include measurement operations and/or performance of other gates on the physical qubits used to determine, for example, expectation values of various operators defined on the lattice (e.g., star operators, triangle operators, logical X operators, logical Z operators, and/or the like).

The quantum circuit may then be compiled into machine level executable instructions for operation of the voltage sources 90, manipulation sources 64, and/or other components of the quantum processor 115. For example, if the quantum circuit indicates that a particular two-qubit gate should be performed on a particular pair of physical qubits at a particular time, the machine level executable instructions include executable instructions configured to cause the voltage sources 90 to generate and provide respective voltage signals configured to cause the particular pair of physical qubits to be located in a common potential well at a target location defined at least in part by the confinement apparatus 50 at the particular time. Moreover, the machine level executable instructions include executable instructions configured to cause the manipulation sources 64 to generate and provide respective manipulation signals to the target location at the particular time, where the respective manipulation signals being incident on the particular pair of physical qubits causes the particular pair of physical qubits to experience the particular two-qubit gate.

In an example embodiment, at least portions of steps 602 and 604 are performed by the classical computing entity 10 and the results thereof are provided to the controller 30. For example, the classical computing entity 10 may provide a quantum circuit and/or quantum program that indicates the braiding to be performed and/or the anyon creation locations and braiding paths.

At step 606, the controller 30 controls operation of components of the QCCD-based quantum processor 115 to cause the at least one pair of anyons to be created at the respective anyon creation locations. For example, the controller 30 may control operation of one or more manipulation sources 64 to cause manipulation signals to be applied to one or more vertex qubits assigned to vertices that link respective anyon creation locations for a pair of non-Abelian anyons. For example, the manipulation signals applied to the one or more vertex qubits are configured to enact an anyon creation gate such as an X-gate (e.g., Pauli X-gate and, in some instances, a controlled X-gate), in an example embodiment, on the one or more vertex qubits. For example, the controller 30 may execute the machine level executable instructions to cause one or more anyon creation gates to be performed in accordance with the quantum circuit.

At step 608, the controller 30 controls operation of components of the QCCD-based quantum processor 115 to cause performance of path traversal gate sequences to cause the created anyons to traverse respective braiding paths. For example, the respective braiding paths may cause a pair of anyons (e.g., two anyons that were created via the same anyon creation gate) to fuse after at least one of the anyons of the pair completes a braiding path. For example, the braiding path may end with a first anyon of the pair of anyons moving to the location of a second anyon of the pair anyons such that the first and second anyons of the pair of anyons fuse to generate a fusion channel.

In various embodiments, the path traversal gate sequence is a sequence of gates performed on physical qubits of the QCCD-based quantum processor 115 that cause the location of the excitation of the non-Abelian topological order, referred to as an anyon or a non-Abelian anyon herein, to change locations on a respective sublattice. In various embodiments, when a non-Abelian anyon of the first sublattice is transported along a braiding path, a path traversal gate sequence includes X-gates performed on the vertex qubits assigned to vertices of the first sublattice located along the braiding path and CZ-gates performed on physical qubits assigned to vertices of the third sublattice along the braiding path (e.g., within the loop of the braiding path) with each preceding vertex of the second sublattice along the braiding path (e.g., within the loop of the braiding path). When a non-Abelian anyon of the second sublattice is transported along a braiding path, a path traversal gate sequence includes X-gates performed on the vertex qubits assigned to vertices of the second sublattice located along the braiding path and CZ-gates performed on physical qubits assigned to vertices of the first sublattice along the braiding path (e.g., within the loop of the braiding path) with each preceding vertex of the third sublattice along the braiding path (e.g., within the loop of the braiding path). When a non-Abelian anyon of the third sublattice is transported along a braiding path, the path traversal gate sequence includes X-gates performed on the vertex qubits assigned to vertices of the third sublattice located along the braiding path and CZ-gates performed on physical qubits assigned to vertices of the second sublattice along the braiding path (e.g., within the loop of the braiding path) with each preceding vertex of the first sublattice along the braiding path (e.g., within the loop of the braiding path).

At step 610, the controller 30 determines one or more fusion channels generated by fusion of pairs of anyons. For example, when a pair of anyons is fused, they produce a fusion channel. The fusion channel produced is a function of the braiding path traversed by at least one of the anyons of the pair of anyons. For example, in the example illustrated in FIGS. 2A-2F, the fusion channel is the identity channel because the braiding path traversed by the first anyon 212A was topologically trivial. However, in the example illustrated in FIG. 4, the fusion channel 408 formed by the fusion of the first and second anyons 402A, 402B of the first sublattice is an Abelian boson on the third sublattice. This non-trivial fusion channel is formed as a result of the non-trivial topology of the braiding path traversed by first anyon 402A which crossed the worldline loop generated by the second pair of anyons on the second sublattice (e.g., anyons 404A, 404B).

For example, for first pair of anyons 402A, 402B which are non-Abelian fluxes on the first sublattice (denoted m_{B}), the fusion channels are provided by m_{B}×m_{B}=1+e_{R}+e_{G}+e_{R}e_{g}, where the “×” symbol indicates the fusion of the non-Abelian fluxes m_{B}, the “+” symbol indicates a listing of possible fusion channels, and eᵢ is an Abelian boson on the ith sublattice. The crossings of the braiding path of the first pair of anyons 402A, 402B controls and/or causes selection of the fusion channel generated when the first pair of anyons 402A, 402B are fused.

As shown in FIG. 4, when a non-Abelian anyon is present at a location, the corresponding triangle operator has an expectation value of approximately −1 and otherwise (e.g., when the non-Abelian anyon is not present) has an expectation value of approximately +1. When an Abelian boson is present at a location, the corresponding start operator has an expectation value of approximately −1 and otherwise (e.g., when an Abelian boson is not present) has an expectation value of approximately +1. Therefore, in various embodiments, a controller 30 can determine the fusion channels present on the lattice by determining the expectation values of the star and/or triangle operators on the lattice.

In various embodiments, determining an expectation of an operator on a plaquette 206 of the lattice 200 includes performing one or more gates on physical qubits assigned to vertices of the lattice corresponding to the plaquette based on operators defined on the lattice (e.g., as shown in FIG. 3). Measurement operations may be performed on one or more of the physical qubits assigned to the vertices of the lattice corresponding to the plaquette to determine the expectation value of the operators. In various embodiments, based on the braiding performed, the determination of the fusion channels present after performance of the quantum circuit is indicative of a result of performance of the quantum circuit, whether any errors and/or which errors occurred during performance of the quantum circuit, and/or the like.

In various embodiments, performing a measurement operation on a physical qubit (e.g., a physical qubit of a QCCD-based quantum processor 115) includes causing a reading manipulation signal that is resonant or near resonant with a particular transition of the physical qubit to be incident on the physical qubit. When the wavefunction of the physical qubit collapses to a first qubit state of the physical qubit, the qubit will fluoresce in response to the reading manipulation signal being incident thereon and when the wavefunction of the physical qubit collapses to a second qubit state of the physical qubit, the qubit will not fluoresce in response to the reading manipulation signal being incident thereon. The optical collection system 80 detects and/or captures any fluorescence generated in response to the reading manipulation signal being incident on the physical qubit. The optical collection system 80 provides sensor signals to the controller 30 (e.g., via A/D converter 725). The controller 30 processes the sensor signals to determine to which qubit state the wavefunction of the physical qubit collapsed.

### Technical Advantages

Complex quantum computations demand levels of precision that are not available in conventional quantum computers due to imperfect control and noise in gate operations between data qubits, for example. Proposed schemes for fault tolerant quantum computing include performing quantum computations on logical qubits that are logically organized based on a selected quantum error correction (QEC) code. Conventional quantum error correction includes the extraction of syndromes which generally includes the interaction of ancilla qubits with data qubits of a logical qubit defined by the QEC code. However, if not performed carefully, such interactions between ancilla qubits and data qubits can cause faults to spread ruinously, leading to logical errors that would have otherwise been correctable given their initial weight. Thus, technical problems exist regarding how to perform quantum computations with levels of precision that are sufficient for performing complex computations.

Various embodiments provide technical solutions to such technical problems. For example, various embodiments provide for the performance of fault tolerate quantum computing and/or fault tolerant quantum error correction using topological quantum computing. Topological quantum computing uses a phase of matter referred to as topological order to perform quantum computations. Topological order is a manifestation of long-range quantum entanglement of a plurality of quantum objects, such as the physical qubits. For example, a concentration of entanglement of the underlaying physical qubits forms a quasiparticle referred to as an anyon. For example, anyons are excitations of topological order (e.g., similar to how phonons are excitations of motional modes of matter). The trajectory of an anyon in four-dimensional spacetime is referred to as the anyon's worldline.

Various embodiments provide for the manipulation of anyons and/or a state of non-Abelian topological order. Non-Abelian topological order is a type of typological order having non-Abelian (e.g., non-commutative) properties. A result of the non-Abelian nature of such a state of matter results in the non-Abelian anyons “remembering” their respective histories. For example, performing Operation A and then performing Operation B on a non-Abelian anyon will provide a different result than performing Operation B and then performing Operation A on the non-Abelian anyon due to the non-commutativity of the non-Abelian topological order. For example, pairs of non-Abelian anyons may be generated and braided together. When the anyons are fused (e.g., when the pairs of non-Abelian anyons are brought back together), the resulting fusion channel will be dependent on how the braiding was performed. For example, when the braiding includes crossings of the worldlines of the anyons that are topologically non-trivial, those crossings cause a toggling of which fusion channel of the possible fusion channels for the fusion of a pair of anyons is created when the pair of anyons is fused. It is expected that these “memory” features of non-Abelian topological order will enable performance of fault tolerant quantum computing using non-Abelian anyons and/or various states of non-Abelian topological order.

Classical simulations are not able to simulate systems and/or matter exhibiting non-Abelian topological order. Therefore, in order to test whether these expectations of fault tolerant computing using non-Abelian topological order will come to bear, states of non-Abelian topological order must be generated and empirically investigated. However, conventional and experimentally successful techniques for the preparation and/or generation of states of non-Abelian topological order are not present in the art. Therefore, technical problems exist regarding the preparation and/or generation of states of non-Abelian topological order. Moreover, technical problems exist regarding to determining whether and/or how topologically-protected quantum computing can provide for higher precision quantum computations.

Various embodiments provide technical solutions to these technical problems. For example, various embodiments provide methods, systems, controllers for systems, computer program products for configuring controllers of systems for manipulating states of a non-Abelian topological order. For example, in various embodiments, one or more pairs of non-Abelian anyons are created, braided, and fused using a plurality of physical qubits of a quantum processor, such as a QCCD-based processor. Various operations may be performed using the non-Abelian anyons.

However, technical problems exist regarding how to manipulate a state of non-Abelian topological order in a physical system. For example, technical problems exist regarding how to manipulate a state of non-Abelian topological order formed by the physical qubits of a trapped ion processor and/or a QCCD-based quantum processor. Various embodiments provide for generation and performance of quantum circuits for creating, braiding, and fusing non-Abelian anyons and, in some instances, determining one or more resulting fusion channels.

Therefore, various embodiments provide technical solutions to the technical problems regarding the manipulation of a state of non-Abelian topological order. Various embodiments therefore provide technical improvements to the fields of fault tolerant and/or topologically-protected quantum computing.

### Example Controller

Various embodiments provide systems comprising confinement apparatuses 50, systems that include a confinement apparatus 50, and/or methods for use thereof. In an example embodiment, the system is a quantum charge-coupled device (QCCD)-based quantum computer 110 or other quantum computer. In various embodiments, the system (e.g., quantum computer 110) further comprises a controller 30 configured to control various elements of the system. For example, the controller 30 is configured to control various components of the system to manipulate a state of a non-Abelian topological order to perform quantum computations. For example, the controller 30 is configured to control various components of the system to create pairs of non-Abelian anyons, cause non-Abelian anyons to traverse respective braiding paths, cause fusion of pairs of non-Abelian anyons to generate fusion channels, and/or to determine the generated fusion channels to perform quantum computations.

For example, the controller 30 may be configured to control the voltage sources 90, a cryogenic system and/or vacuum system for controlling the temperature and pressure within the cryogenic and/or vacuum chamber 40, manipulation sources 64 (e.g., 64A, 64B, 64C), active components of beam path systems 66 (e.g., 66A, 66B, 66C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more quantum objects (e.g., physical qubits) confined by the confinement apparatus 50, and/or read and/or measure a quantum state of one or more quantum objects confined by the confinement apparatus.

As shown in FIG. 7, in various embodiments, the controller 30 may comprise various controller elements including one or more processing elements 705, memory 710, driver controller elements 715, a communication interface 720, analog-digital converter elements 725, and/or the like. For example, the one or more processing elements 705 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing elements 705 of the controller 30 comprises a clock and/or is in communication with a clock. In various embodiments, this clock defines the clock cycles of the system.

For example, the memory 710 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store qubit records corresponding to the logical and/or physical qubits of quantum computer (e.g., in a qubit record data store, qubit record database, qubit record table, and/or the like), a calibration table, an executable queue, computer program code or executable instructions (e.g., in a one or more computer languages, specialized controller language(s), and/or the like), and/or the like. In an example embodiment, execution of at least a portion of the computer program code or executable instructions stored in the memory 710 (e.g., by a processing element 705) causes the controller 30 to perform one or more steps, operations, processes, procedures and/or the like described herein for controlling one or more components of the quantum computer 110 (e.g., voltage sources 90, manipulation sources 64, magnetic field sources 70, and/or the like) to cause a controlled evolution of quantum states of one or more quantum objects, measure and/or read the quantum state of one or more quantum objects, and/or the like. For example, execution of at least a portion of the computer program code or executable instructions stored in the memory 710 (e.g., by a processing element 705) causes the controller 30 to perform one or more steps, operations, processes, procedures and/or the like of the flowchart of FIG. 6, in an example embodiment.

In various embodiments, the driver controller elements 715 may include one or more drivers and/or controller elements each configured to control one or more drivers. In various embodiments, the driver controller elements 715 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 705). In various embodiments, the driver controller elements 715 may enable the controller 30 to operate a manipulation source 64. In various embodiments, the drivers may be laser drivers; vacuum component drivers; drivers for controlling the flow of current and/or voltage applied to RF, control, and/or other electrodes (e.g., shim electrodes and/or the like) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the control electrodes and/or RF electrodes of the confinement apparatus 50.

In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optical collection system 80. For example, the controller 30 may comprise one or more analog-digital converter elements 725 configured to receive signals from one or more detectors, optical receiver components, calibration sensors, and/or the like.

In various embodiments, the controller 30 may comprise a communication interface 720 for interfacing and/or communicating with one or more computing entities 10. For example, the controller 30 may comprise a communication interface 720 for receiving executable instructions, command sets, and/or the like from the computing entity 10 and providing output received from the quantum processor 115 (e.g., via the optical collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Example Computing Entity

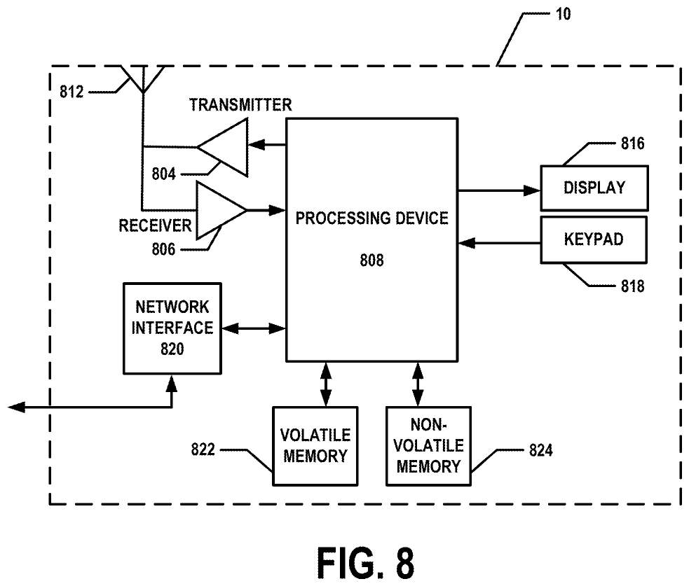

FIG. 8 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 8, a computing entity 10 can include an antenna 812, a transmitter 804 (e.g., radio), a receiver 806 (e.g., radio), and a processing device 808 that provides signals to and receives signals from the transmitter 804 and receiver 806, respectively.

The signals provided to and received from the transmitter 804 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 820 configured to communicate via one or more wired and/or wireless networks 20.

The computing entity 10 may also comprise a user interface device comprising one or more user input/output interfaces (e.g., a display 816 and/or speaker/speaker driver coupled to a processing device 808 and a touch screen, keyboard, mouse, and/or microphone coupled to a processing device 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for creating, braiding, and fusing non-Abelian anyons, the method comprising:
controlling operation of a confinement apparatus to cause a plurality of physical qubits to be confined by the confinement apparatus, wherein at least some of the plurality of physical qubits are logically organized onto a lattice and have been prepared to provide a non-Abelian topological order ground state, wherein the lattice comprises a plurality of vertices connected by edges, wherein the lattice is formed of a plurality of sublattices, wherein each sublattice comprises a respective plurality of vertices of the plurality of vertices, the respective plurality of vertices of a sublattice of the plurality of sublattices are connected by edges to form the sublattice;
causing performance of an anyon creation gate to cause creation of a first pair of non-Abelian anyons on a first sublattice of the plurality of sublattices;
causing a path traversal gate sequence to be performed to cause at least a first anyon of the first pair of non-Abelian anyons to traverse a first braiding path to form a closed loop on the first sublattice; and
determining a first fusion channel of fusing the first pair of non-Abelian anyons.

2. The method of claim 1, wherein the anyon creation gate is an X-gate and causing generation of the first pair of non-Abelian anyons on the first sublattice comprises performing an X-gate on a creation location first vertex qubit of the first sublattice, the creation location first vertex qubit being a physical qubit of the plurality of physical qubits assigned to a vertex of the first sublattice that links a creation location of the first anyon of the first pair of non-Abelian anyons and a creation location of a second anyon of the first pair of non-Abelian anyons.

3. The method of claim 1, wherein the path traversal gate sequence comprises a plurality of Pauli-X gates performed on vertices of the first sublattice along the braiding path and a plurality of controlled Z-gates each performed on a respective pair of physical qubits that includes a second vertex qubit and a third vertex qubit, wherein the second vertex qubit is a physical qubit of the plurality of physical qubits that is assigned to a vertex of the second sublattice and the third vertex qubit is a physical qubit of the plurality of physical qubits that is assigned to a vertex of the third sublattice.

4. The method of claim 3, wherein the plurality of controlled Z-gates comprises controlled Z-gates performed on each third vertex qubit along the first braiding path with each preceding second vertex qubit along the first braiding path.

5. The method of claim 1, further comprising:
causing generation of a second pair of non-Abelian anyons on a second lattice of the plurality of sublattices, wherein performance of the path traversal gate sequence further causes at least a first anyon of the second pair of non-Abelian anyons to traverse a second braiding path to form a closed loop on the second sublattice so as to form a second fusion channel.

6. The method of claim 5, wherein the first fusion channel is one of a plurality of possible fusion channels for the first pair of non-Abelian anyons and any crossings of the first braiding path and the second braiding path affects which fusion channel of the plurality of possible fusion channels is formed as the first fusion channel.

7. The method of claim 1, wherein determining the first fusion channel comprises determining one or more expectation values for one or more operators defined on the lattice.

8. The method of claim 1, further comprising:
determining a creation location first vertex qubit and the first braiding path; and
generating a set of machine level executable instructions for causing performance of the anyon creation gate and the path traversal gate sequence.

9. The method of claim 1, wherein a gate used to create the first pair of non-Abelian anyons and each gate of the path traversal gate sequence performed on the first sublattice is controlled by one or more ancilla qubits of the plurality of physical qubits.

10. The method of claim 1, wherein the lattice is a Kagome lattice having periodic boundary conditions.

11. A system configured for creating, braiding, and fusing non-Abelian anyons, the system comprising:
a confinement apparatus configured to confine a plurality of physical qubits;
one or more manipulation sources configured to generate respective manipulation signals for interaction with respective physical qubits of the plurality of physical qubits; and
a controller configured to control operation of the confinement apparatus and the one or more manipulation sources, the controller configured to perform:
controlling operation of the confinement apparatus to cause the plurality of physical qubits to be confined by the confinement apparatus, wherein at least some of the plurality of physical qubits are logically organized onto a lattice and have been prepared to provide a non-Abelian topological order ground state, wherein the lattice comprises a plurality of vertices connected by edges, wherein the lattice is formed of a plurality of sublattices, wherein each sublattice comprises a respective plurality of vertices of the plurality of vertices, the respective plurality of vertices of a sublattice of the plurality of sublattices are connected by edges to form the sublattice;
causing performance of an anyon creation gate to cause creation of a first pair of non-Abelian anyons on a first sublattice of the plurality of sublattices;
causing a path traversal gate sequence to be performed to cause at least a first anyon of the first pair of non-Abelian anyons to traverse a first braiding path to form a closed loop on the first sublattice; and
determining a first fusion channel of fusing the first pair of non-Abelian anyons.

12. The system of claim 11, wherein the anyon creation gate is an X-gate and causing generation of the first pair of non-Abelian anyons on the first sublattice comprises performing an X-gate on a creation location first vertex qubit of the first sublattice, the creation location first vertex qubit being a physical qubit of the plurality of physical qubits assigned to a vertex of the first sublattice that links a creation location of the first anyon of the first pair of non-Abelian anyons and a creation location of a second anyon of the first pair of non-Abelian anyons.

13. The system of claim 11, wherein the path traversal gate sequence comprises a plurality of Pauli-X gates performed on vertices of the first sublattice along the braiding path and a plurality of controlled Z-gates each performed on a respective pair of physical qubits that includes a second vertex qubit and a third vertex qubit, wherein the second vertex qubit is a physical qubit of the plurality of physical qubits that is assigned to a vertex of the second sublattice and the third vertex qubit is a physical qubit of the plurality of physical qubits that is assigned to a vertex of the third sublattice.

14. The system of claim 13, wherein the plurality of controlled Z-gates comprises controlled Z-gates performed on each third vertex qubit along the first braiding path with each preceding second vertex qubit along the first braiding path.

15. The system of claim 11, wherein the controller is further configured to perform causing generation of a second pair of non-Abelian anyons on a second lattice of the plurality of sublattices, wherein performance of the path traversal gate sequence further causes at least a first anyon of the second pair of non-Abelian anyons to traverse a second braiding path to form a closed loop on the second sublattice so as to form a second fusion channel.

16. The system of claim 15, wherein the first fusion channel is one of a plurality of possible fusion channels for the first pair of non-Abelian anyons and any crossings of the first braiding path and the second braiding path affects which fusion channel of the plurality of possible fusion channels is formed as the first fusion channel.

17. The system of claim 11, wherein determining the first fusion channel comprises determining one or more expectation values for one or more operators defined on the lattice.

18. The system of claim 11, wherein the controller is further configured to perform:
determining a creation location first vertex qubit and the first braiding path; and
generating a set of machine level executable instructions for causing performance of the anyon creation gate and the path traversal gate sequence.

19. The system of claim 11, wherein a gate used to create the first pair of non-Abelian anyons and each gate of the path traversal gate sequence performed on the first sublattice is controlled by one or more ancilla qubits of the plurality of physical qubits.

20. The system of claim 11, wherein the lattice is a Kagome lattice having periodic boundary conditions.
